(19) United States
(12) Patent Application Publication
(10) Pub. No.: US 2026/0356121 A1
(43) Pub. Date: Nov. 12, 2026

(54) BRUSH CLEANING DEVICE AND METHOD

(71) Applicant: Ardell J Shaw, Reno, NV (US)

(72) Inventor: Ardell J Shaw, Reno, NV (US)

(21) Appl. No.: 19/565,460

(22) Filed: Mar. 12, 2026

Related U.S. Application Data
(60) Provisional application No. 63/770,864, filed on Mar. 12, 2025.

(51) Int. Cl. B44D 3/00; A46B 17/06

(52) U.S. Cl. CPC B44D 3/006; A46B 17/06; A46B 2200/202

(57) ABSTRACT

A paint brush cleaning device and method are disclosed. The device includes an angled cleaning surface supported at an angle to a support surface by one or more supports. The angled cleaning surface comprises a lower angled portion, an upper angled portion, and a step located between the upper and lower angled portions. In use, a paint brush is placed onto the cleaning surface with a ferrule of the brush located at the step, and bristles of the brush supported over the lower angled portion. Water is applied to the bristles to rinse paint therefrom, and the bristles may be manipulated against the angled surface to further loosen and remove paint. The cleaning surface may include one or more slots for allowing water to pass through the device, and a holder for receiving a handle of the paint brush.

### FIELD OF THE INVENTION

This application claims priority to U.S. Provisional Patent Application Ser. No. 63/770,864 filed Mar. 12, 2025, the entire contents of each of which are incorporated herein by reference.

### BACKGROUND OF THE INVENTION

Paint brushes can be difficult to clean in a tidy manner. Typically, the brush must be run under water until the water running off the brush is not tainted by any paint. Even then, there can be paint caught deep in the bristles of the brush that can lead to reduced performance of the brush. Reduced performance may include paint of one color tainting paint of another, stiff brush bristles, or stray and uneven bristles.

The amount of water required to clean the paint brush can cause water containing paint to be splashed to unwanted places where, if allowed to dry, can lead to paint stains on surfaces.

What is required is a device and method that facilitates better and tidier cleaning of paint brushes.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to support a paint brush during a cleaning operation;

provide a means to more effectively clean a paint brush;

provide a device that can be used in an interior facility such as a sink or basin for cleaning of a paint brush;

provide a device that can be used at exterior water sources;

provide a portable brush cleaning device;
provide a device that allows user to bend the brush to loosen paint within the bristles of the brush.

These and other advantages may be realized by reference to the remaining portions of the specification, claims, and abstract.

### BRIEF DESCRIPTION OF ONE EMBODIMENT OF THE PRESENT INVENTION

In one aspect of the present invention, there is a provided a paint brush cleaning device. The paint brush cleaning device may comprise an angled cleaning surface. The angled cleaning surface may include an upper angled portion, a lower angled portion and a step between the upper angled portion and the lower angled portion. One or more supports may support the angled cleaning surface at an angle to a surface.

In one aspect of the present invention, there is provided a method for cleaning a paint brush. The method may comprise locating a brush cleaning device at a water source. The brush cleaning device may comprise an angled cleaning surface, the angled cleaning surface comprising a step. The method may comprise locating a paint brush onto the angled cleaning surface and applying water to the angled cleaning surface.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a side view of a brush cleaning device in accordance with an embodiment of the present disclosure;

FIG. 2 shows a front view of the device of FIG. 1;

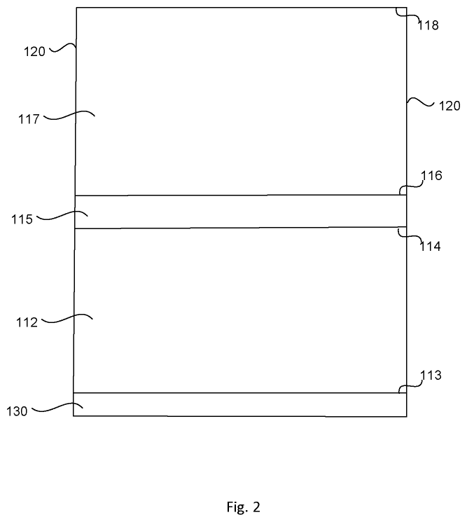

FIG. 3 shows a top perspective view of an alternative embodiment of a brush cleaning device;

FIG. 4 shows a side view of the device of FIG. 3;

FIG. 5 shows a flowchart of a method for using a brush cleaning device;

FIG. 6 shows a device in use located within a sink to clean a paint brush.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

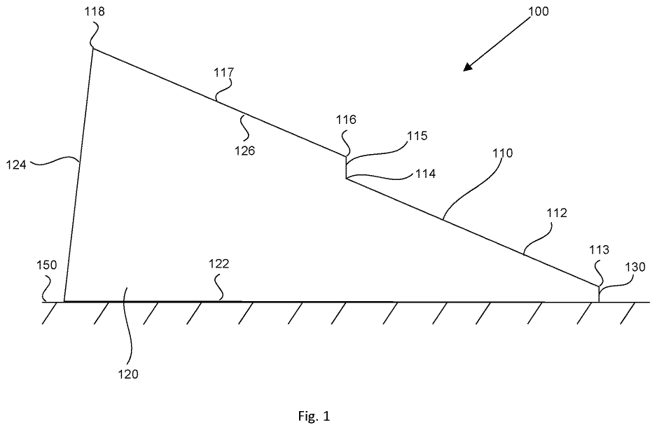

In FIG. 1, there is shown a device 100 for cleaning paint brushes. The device 100 includes a cleaning surface 110 and one or more supports 120 for supporting the cleaning surface 110 at an angle to a support surface 150. The cleaning surface 110 may be considered to be a stepped ramp having an lower angled portion 112 leading from a bottom edge 113 to a top edge 114 where it meets an upward step 115. The step 115 extends from its bottom edge 113 (the top edge of the lower angled portion 112) to a top edge 116. An upper angled portion 117 extends from a bottom edge (the top edge 116 of the step 115) to a top edge 118.

The bottom edge 113 of the lower angled portion may rest on the support surface. Alternatively, as depicted, a base portion 130 may be formed under the stepped ramp 110 so that the ramp 110 is held above the support surface 150.

The supports 120 may be side panels having a base edge 122, a back edge 124 and an angled edge 126 that matches the profile of the stepped ramp 110. The supports rest on a support surface and support the stepped ramp cleaning surface 110 at an angle to the surface 130.

A back panel may optionally be provided or the back or the device 100 may be open.

In one embodiment, the side panels and/or back panel may include one or more cutouts at their bottom edge to allow water to flow under the device.

In an alternative embodiment, the side and back panels may be replaced by one or more props, legs or feet that support the stepped ramp cleaning surface at an angle to the support surface.

The device 100 may be injected molded, vacuum formed, 3D printed, made from wood, sheet metal, etc. In one embodiment, the device 100 may be approximately 5 inches wide and 10 inches long. The angle of the ramp may be any suitable angle. For example, the ramp may be angled between 15 and 45 degrees.

To use the device 100, the device 100 may be placed under a water source, such as within a sink, basin or an outdoor surface adjacent a tap, faucet or hose. A user places a brush onto the stepped ramp, locating the brush ferrule at the location of the step 115. The bristles are located adjacent the lower angled portion 112 of the ramp 110. Water can be applied continuously onto the bristles to rinse paint from the bristles. The corner on the ramp allows the user to bend the bristles downward. The user can then flip the brush over and bend in it the other direction. This helps loosen paint between the bristles. The user can use a wire brush or similar to brush out the bristles.

The device is portable, can be used interior or exterior and can protect a multitude of surfaces.

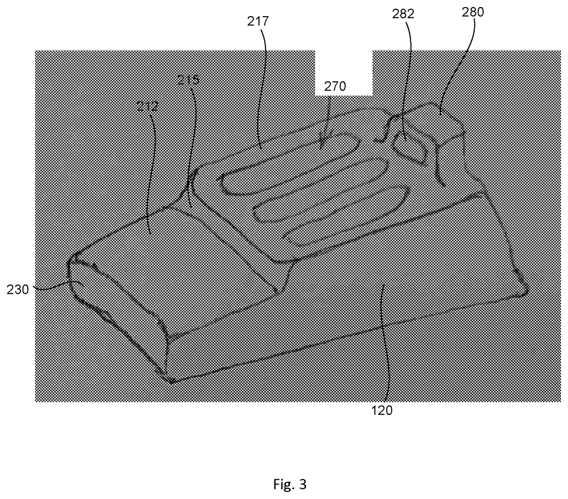

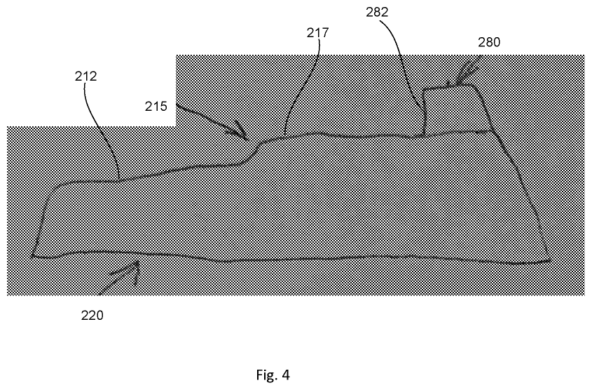

An alternative embodiment 200 of the device is illustrated in FIGS. 3 and 4. In this embodiment, the device 200 may include a series of ribbed slots 270 in one or both of the upper angle surface 217 and the lower angled surface 212 for strengthening the device and for allowing water to pass through the device. The device 200 may also include a support 280 with an hole 282 that receives a handle of the brush to support the brush during cleaning. The side panel 220 may also include a cut out for allowing water to flow more freely under the device 200.

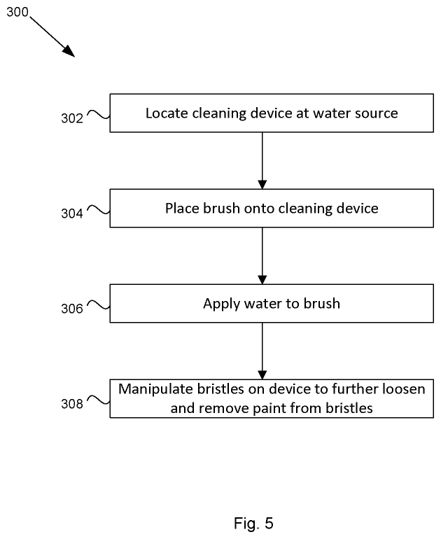

FIG. 5 shows a flowchart 300 of a method for cleaning a paint brush. At step 302, a paint brush cleaning device, such as the device 100 or device 200 described above may be located at a water source. At step 304, a paint brush is located onto a device such as device 100 or device 200. The paint brush may be located with the ferrule of the paint brush resting on an upper edge of a step 115, 215 of the device and so that the bristles of the brush are supported above the lower angled slope 112, 212 of the device. Water may be projected onto the bristles 306 to remove paint from within the bristles. The brush bristles may be manipulated 308 against the lower surface of angled surface 112, 212 of the device to further loosen paint from within the bristles.

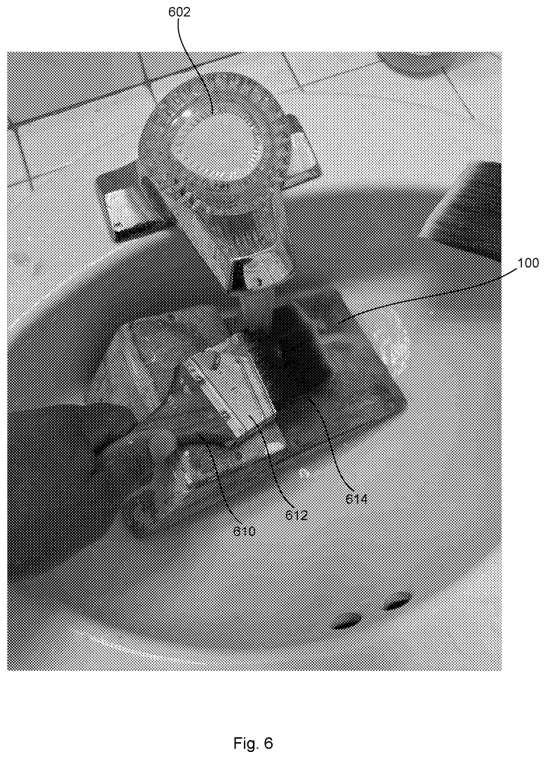

FIG. 6 shows the device 100 in use, placed inside a sink under a tap 602. A brush 610 is placed on the device 100 with the ferrule 612 aligning with the edge of the step of the device 100. The bristles 614 are located over the lower angled portion and under the water from the tap 602.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A paint brush cleaning device comprising:
(A) an angled cleaning surface;
(B) one or more supports for support the angled cleaning surface at an angle to a surface;
(C) wherein the angled cleaning surface comprises:
(a) an upper angled portion;
(b) a lower angled portion;
(c) a step between the upper angled portion and the lower angled portion.

2. The paint brush cleaning device of claim 1 comprising one or more slots for allowing water to pass through the cleaning device.

3. The paint brush cleaning device of claim 1 comprising a holder for receiving a handle of a paint brush.

4. A method for cleaning a paint brush comprising:
(A) locating a brush cleaning device at a water source, the brush cleaning device comprising an angled cleaning surface, the angled cleaning surface comprising a step;
(B) locating a paint brush onto the angled cleaning surface;
(C) applying water to the angled cleaning surface.

5. The method of claim 4 wherein locating the paint brush onto the angled cleaning surface comprises locating a ferrule of the paint brush at the step.
